(19) United States
(12) Patent Application Publication
(10) Pub. No.: US 2017/0168796 A1
(43) Pub. Date: Jun. 15, 2017

(54) METHOD AND ELECTRONIC APPARATUS FOR TRANSFERRING APPLICATION PROGRAM FROM PC TO MOBILE APPARATUS

(71) Applicants: LE HOLDINGS (BEIJING) CO., LTD., Beijing (CN); LE SHI INTERNET INFORMATION TECHNOLOGY CORP. BEIJING, Beijing (CN)

(72) Inventor: Ying LIANG, Beijing (CN)

(73) Assignees: LE HOLDINGS (BEIJING) CO., LTD., Beijing (CN); LE SHI INTERNET INFORMATION TECHNOLOGY CORP. BEIJING, Beijing (CN)

(21) Appl. No.: 15/246,368

(22) Filed: Aug. 24, 2016

Related U.S. Application Data
(63) Continuation of application No. PCT/CN2016/088512, filed on Jul. 5, 2016.

(30) Foreign Application Priority Data
Dec. 11, 2015 (CN) 201510920205.6

(51) Int. Cl. G06F 9/445

(52) U.S. Cl. CPC G06F 8/61

(57) ABSTRACT

A method and electronic apparatus for transferring application program from PC to mobile apparatus including: receiving information that the mobile apparatus is already connected to the PC sent from the PC by a PC end application program installed at the PC and in an opened state; detecting whether the mobile apparatus is permitted to install the application program and whether a user agrees to install the application program; installing the application program, which is previously downloaded to the PC and related to the PC end application program, to the mobile apparatus by the PC end application program when the mobile apparatus is permitted to install the application program to the mobile apparatus and the user agrees to install the application program to the mobile apparatus, for transferring the application program from the PC end to the mobile apparatus end affects user experience and having low efficiency in transferring.

### CROSS REFERENCE TO RELATED APPLICATIONS

This application is a continuation of International Application No. PCT/CN2016/088512, filed on Jul. 5, 2016, which is based upon and claims priority to Chinese Patent Application No. 201510920205.6, filed on Dec. 11, 2015, the entire contents of which are incorporated herein by reference.

### TECHNICAL FIELD

The present disclosure relates to an intelligent application, more particularly to a method and electronic apparatus for transferring application program from a PC to a mobile apparatus.

### BACKGROUND

With the development of mobile apparatus (smartphone, tablet computer), traditional PCs (Personal Computer) somehow will be partly replaced by the mobile apparatus, a great amount of application program in PC accumulated overtime being efficiently transferred to mobile apparatus end is the current development trend in industries.

Currently, traditional methods for transferring application program from a PC end to a mobile apparatus end includes: 1. jump to application stores (e.g. Apple Store or android market .etc) at the mobile apparatus end to download the application program by scanning 2D Barcode at the mobile apparatus end; 2. download application program to the PC via the browser at PC end, and then copy the application program to the mobile apparatus end to be installed.

### SUMMARY

One embodiment of the present disclosure provides a method and electronic apparatus for transferring application program from a PC to a mobile apparatus, for solving the problem in the traditional technology that the method for transferring the application program from the PC end to the mobile apparatus end affects user experience and having low efficiency in transferring.

On the first aspect, one embodiment of the present disclosure provides a method for transferring application program from a PC to a mobile apparatus, the method includes:

receiving information that the mobile apparatus is already connected to the PC sent from the PC by a PC end application program which is installed at the PC and in an opened state;

detecting whether the mobile apparatus is permitted to install the application program to the mobile apparatus and whether a user agrees to install the application program to the mobile apparatus, by the PC end application program; and

installing the application program, which is previously downloaded to the PC and related to the PC end application program, to the mobile apparatus by the PC end application program when the mobile apparatus is permitted to install the application program to the mobile apparatus and the user agrees to install the application program to the mobile apparatus.

On the second aspect, one embodiment of the present disclosure provides a non-volatile computer storage medium capable of storing computer-executable instruction. The said computer-executable instruction is used for performing any one of the steps in above.

One embodiment of the present disclosure provides an electronic apparatus, includes:

at least one processor; and

a memory communicatively connected to the at least one processor; wherein,

the memory stores at least one instruction which can be performed by the processor. The instruction is performed by the at least one processor so that the at least one processor can perform any one of the step as discussed in above.

The method and the electronic apparatus for transferring the application program from the PC to the mobile apparatus provided by one embodiment of the present disclosure, the user can install the application program which is previously downloaded the local PC when the client mobile apparatus satisfies installation authorization, so the human resource cost is low in the entire process, and user experience and efficiency in transferring can be improved; after the installation of the application program to the mobile apparatus end is finished, operating data of the PC end application program will be synchronously transferred to the application program at the mobile apparatus end, thereby optimizing user experience; in addition, the PC end application program is able to update and install the application program of the mobile apparatus end, and thereby saving human resource cost and improving user experience.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flow diagram illustrating a method for transferring an application program from a PC to a mobile apparatus according to some embodiments of the present disclosure;

FIG. 2 is another flow diagram illustrating a method for transferring the application program from the PC to the mobile apparatus according to some embodiments of the present disclosure;

FIG. 3 is yet another flow diagram illustrating a method for transferring the application program from the PC to the mobile apparatus according to some embodiments of the present disclosure;

FIG. 4 is yet another flow diagram illustrating a method for transferring the application program from the PC to the mobile apparatus according to some embodiments of the present disclosure;

FIG. 5 is yet another flow diagram illustrating a method for transferring the application program from the PC to the mobile apparatus according to some embodiments of the present disclosure;

FIG. 6 is a block diagram illustrating a PC client end for transferring the application program from the PC to the mobile apparatus according to some embodiments of the present disclosure;

FIG. 7 is another block diagram illustrating a PC client end for transferring the application program from the PC to the mobile apparatus according to some embodiments of the present disclosure;

FIG. 8 is yet another block diagram illustrating a PC client end for transferring the application program from the PC to the mobile apparatus according to some embodiments of the present disclosure;

FIG. 9 is yet another block diagram illustrating a PC client end for transferring the application program from the PC to the mobile apparatus according to some embodiments of the present disclosure;

FIG. 10 is yet another block diagram illustrating a PC client end for transferring the application program from the PC to the mobile apparatus according to some embodiments of the present disclosure; and

FIG. 11 is yet another block diagram illustrating a PC client end according to some embodiments of the present disclosure.

### DETAILED DESCRIPTION

For more clearly illustrating the purpose, technology and advantages of the present disclosure, the following paragraphs and related drawings are provided for thoroughly describing the features of the embodiments of the present disclosure. It is evident that these embodiments are merely illustrative and not exhaustive embodiments of the present disclosure. Based on the embodiments in the present disclosure, the other embodiments conceived by the people skilled in the art without putting inventive effort fall within the scope of the present disclosure.

### First Embodiment

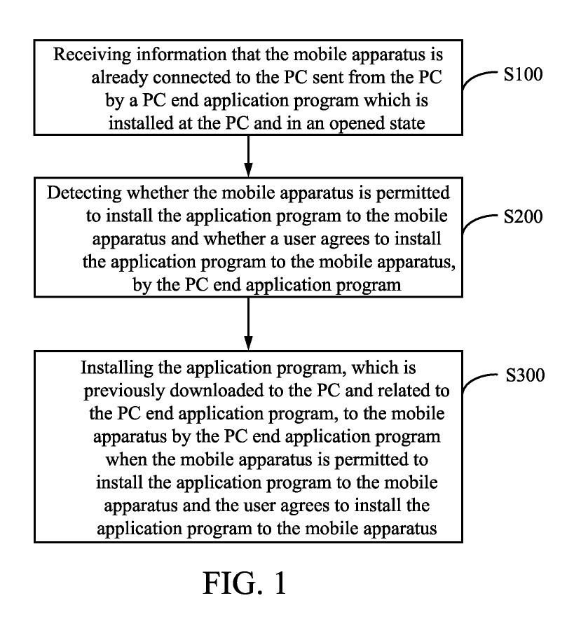

For solving the problem that traditional methods of transferring the application program from the PC end to the mobile apparatus end affects user experience and has low efficiency in transferring, one embodiment of the present disclosure provides a method for transferring application program from a PC to a mobile apparatus. Wherein, the PC is a personal computer, the mobile apparatus includes smartphone, tablet computer .etc, the PC end application program (application program) is a software operated in the PC, the application program (application program) is a software installed in the mobile apparatus, but these aforementioned examples are classic names in the art of the present disclosure, the present disclosure is not limited thereto. Please refer to FIG. 1, the method for transferring the application program from the PC to the mobile apparatus includes:

step S100: receiving information that the mobile apparatus is already connected to the PC sent from the PC by a PC end application program which is installed at the PC and in an opened state;

step S200: detecting whether the mobile apparatus is permitted to install the application program to the mobile apparatus and whether a user agrees to install the application program to the mobile apparatus, by the PC end application program;

step S300: installing the application program, which is previously downloaded to the PC and related to the PC end application program, to the mobile apparatus by the PC end application program when the mobile apparatus is permitted to install the application program to the mobile apparatus and the user agrees to install the application program to the mobile apparatus.

In the step S100, firstly, the PC end application program in the PC should be at an opened state, the opened state means that the main process of the PC end application program at the PC is at an operating state; Secondly, by the PC, the information that the mobile apparatus is already connected to the PC is sent to the PC end application program, for example, the windows system of the PC will atomically send WM_DEVICECHANGE information to the PC end application program when the mobile apparatus is connected to the PC, the mobile apparatus already connected to the PC further includes: the mobile apparatus connected to the PC via a USB data cable, and the mobile apparatus is connected to the PC via wireless way, that is, cable connection and wireless connection. The data cable connection means to use the USB data cable of the mobile apparatus to connect the USB interface of the PC and the data transmission interface of the mobile apparatus; the wireless connection includes the PC and the mobile apparatus connected to WIFI located in the same area, or the PC and the mobile apparatus wirelessly connected to each other through Bluetooth module thereof, but it does not provide specific limitation on the connection between the PC and the mobile apparatus. When the PC end application program receives the WM_DEVICECHANGE, if the parameter in the WM_DEVICECHANGE is DBT_DEVICEARRIVAL, which means the data cable of the mobile apparatus is plugged into the USB hole on the PC, on the contrary, if the wparam is DBT_DEVICEREMOVECOMPLETE, which means the data cable of the mobile apparatus is unplugged from the USB hole on the PC. The present disclosure is operated basing on that the mobile apparatus is already connected to the PC, so the situation that the mobile apparatus is not connected to the PC is obviously not adapted to the method of the present disclosure, and is not possible to achieve that the PC end transfers the user resource to the mobile apparatus end.

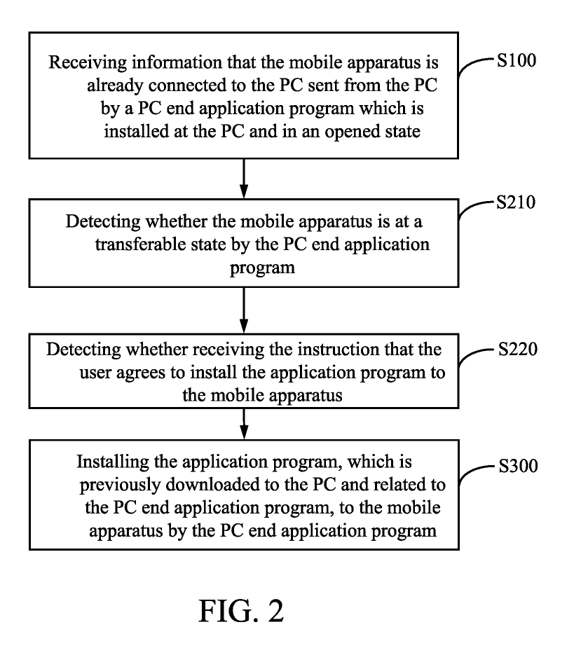

In the step S200, continued from the step S100, please refer to FIG. 2, the method that the PC end application program detects whether the mobile apparatus is permitted to install the application program to the mobile apparatus and whether a user agrees to install the application program to the mobile apparatus, further includes:

step S210: detecting whether the mobile apparatus is at a transferable state by the PC end application program, wherein, the transferable state includes: when the mobile apparatus is connected to the PC via the USB data cable, a USB debugging mode of the mobile apparatus is opened, and the mobile apparatus is already agreed with authorization; or when the mobile apparatus is connected to the PC via wireless way, the mobile apparatus is already agreed with authorization;

step S220: detecting whether receiving the instruction that the user agrees to install the application program to the mobile apparatus.

Specifically, after the PC end application program receives the information that the mobile apparatus is connected to the PC, the PC end application program will detect the state of the mobile apparatus via adb.exe of Google, that is, detect whether the state of the mobile apparatus is at the transferable state. Of course, the present disclosure assumes that the mobile apparatus is at the transferable state, as discussed in above, the mobile apparatus not at the transferable state can not be adapted to the method of the present disclosure, and is impossible to transfer user resource from the PC end to the mobile apparatus end.

Here, when the mobile apparatus is connected to the PC through the USB data cable, the transferable state is required to satisfy the following two conditions: the USB debugging mode of the mobile apparatus is opened; and the mobile apparatus is already agreed with authorization. The USB debugging mode of the mobile apparatus being opened means the USB debugging mode in the setting operation or security operation in the mobile apparatus is selected, which means the USB data cable of the mobile apparatus is opened so that the mobile apparatus is able to transfer data with outer apparatus. As everyone knows, the data cable and the charging cable of the traditional mobile apparatus (e.g. smartphone) are combined into single cable, when the USB debugging mode is not opened, the phone can be charged via the charging cable; when the USB debugging mode is opened, the charging cable and the data cable can be used at the same time, that is, the phone can be charged and exchanges data with the outer apparatus at the same time. The mobile apparatus already agreed with authorization means that the mobile apparatus agrees the installation of application program from unknown resource, take the phone as an example, each mobile phone manufacturer has their application market, the mobile phone usually recognizes the installation process made by its own manufacturer when installing, so it needs user to change the setting, users usually select the application market both from unknown resource and the brand of its phone, so the phone will take that it is already agreed with authorization so that the phone can be installed with the application programs from different markets. It is needed to be pointed out that these two conditions are necessary to that the mobile apparatus is at the transferable state.

In addition, when the mobile apparatus is connected to the PC via wireless way, the transferable state is required to satisfy the following condition: the mobile apparatus is already agreed with authorization. Here, the wireless way for connecting the mobile apparatus and the PC is a protocol transferring not requiring the USB debugging mode, thus the transferable state is merely required to satisfy that the mobile apparatus is already agreed with authorization, the agreement authorization herein is described in above in detail, so it is not repeated herein.

After the PC end application program detects that the mobile apparatus is at the transferable state, information will be suggested to the PC end application program in operation to tell the user that the application program is able to be installed to the mobile apparatus. Here, the way of suggesting the information can be: a notification popped out from the visual interface of the PC end application program, or a dialog popped out from the PC end application program, of course, the information can be accompanied by an audio notification when the information is suggested so that the user still can get this information when not focusing on the PC screen, the aforementioned information form and ways for notification are parts of achieving the present disclosure, the present disclosure is not limited thereto. In addition, for attracting and guiding the user to transfer the application program from the PC end to the mobile apparatus end, the suggested information can be accompanied by some promotion activities, e.g. free to become a member, promotion page of installing step, it can be altered according to actual application program.

When the suggested information is informed to the user, the user is able to send feedback with respect to the suggested information to interactively operate his/her will and the PC end application program, for example, via mouse cursor or “on touch to install” touch operation, but the present disclosure is not limited to the ways of interactive operation. The PC end application program receiving the instruction of agreement in installing the application program to the mobile apparatus is an instruction from that the user uses the mouse cursor or“one touch to install” touch operation to be transferred to the PC end application program for the PC end application program to receive the user's agreement of installing the application program to the mobile apparatus. It is noted to be pointed out that the present disclosure is operated basing on the user's agreement of installing the application program to the mobile apparatus, as discussed in above, the disagreement in installing the application program to the mobile apparatus is not adapted to the methods of the present disclosure, and it is impossible to transfer the user resource from the PC end to the mobile apparatus end.

In the step S300, continued from the step S200, when the PC end application program receives the instruction of user's agreement in installing the application program to the mobile apparatus, a local memory in the PC will be used, an installation process of the application program previously downloaded in the memory is installed into the mobile apparatus, wherein the installation operation is performed basing on when the mobile apparatus is permitted to be installed into the application program and the user agrees to install the application program to the mobile apparatus, if the mobile apparatus is not permitted to be installed the application program or the user disagrees to install the application program to the mobile apparatus, the installation operation will not be performed. Here, the application program and the PC end application program are related, for example, the application program and the PC end application program are products in the same category, the application program and the PC end application program are products belonged to the company, but the present disclosure is not limited to the further details of the relationship. The PC will download the installation process of the application program adapted to the mobile apparatus to the downloaded file when installing the PC end application program, and will automatically download the latest version of the installation process to replace the older version of the installation process when the Office of the application program updates the version, for ensuring that the application program on the mobile apparatus is the latest version, and everybody knows that the application program in the newer version can provide better user experience than the application program in older version, that is, for ensuring that the use can has the best user experience during using the application program on the mobile apparatus.

During the entire installation process, from the mobile apparatus connected to the PC to the finish of the installation of the application program, the use is merely required to select the agreement to install the application program to the mobile apparatus for one time, so the human resource cost for transferring is low, thereby improving the user experience and preventing the transferring from failing caused by that the user might fed up with repeatedly selecting options, so the success rate in transferring the application program is improved.

In addition, in one embodiment, the PC end application program and the application program are respectively a PC version and a mobile apparatus version of the same application program, for example, the PC end application program is a PC version of LETV, and the application program is a mobile version of LETV, but the present disclosure is not limited to this example. It is conceivable that the PC end application program can transfer different application programs to the mobile apparatus.

### Second Embodiment

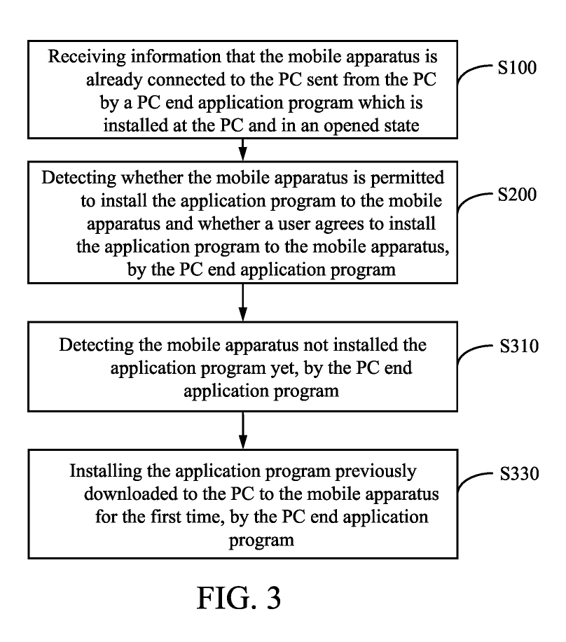

Please refer to FIG. 3, this embodiment is based on the first embodiment, the method that the PC end application program installs the application program which is previously downloaded to the PC and is related to the PC end application program to the mobile apparatus, further includes:

step S310: detecting the mobile apparatus not installed the application program yet, by the PC end application program;

step S330: installing the application program previously downloaded to the PC to the mobile apparatus for the first time, by the PC end application program.

In the step S310, the PC end application program reads an installation state of the mobile apparatus, when detecting the mobile apparatus not installed with the application program, that is, it means that the application program previously downloaded to the PC is never installed in the mobile apparatus, for example, the PC end application program is detected that the mobile apparatus is installed with A, B, C, D and E, five application programs, the application program F is the one previously downloaded to the PC, which means that the PC end application program detects the mobile apparatus not installed with the application program.

In the step S330, when it is confirmed that the application program is not installed on the mobile apparatus yet, the PC end application program will install the application program previously downloaded to the PC to the mobile apparatus for the first time, the installation for the first time means that the first time installation, that is, the application program is not installed into the mobile apparatus yet.

### Third Embodiment

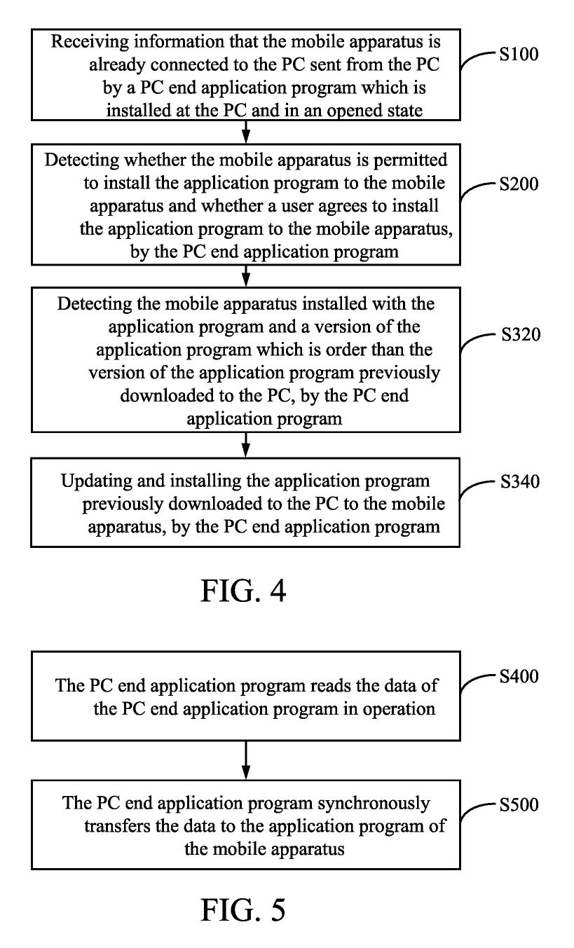

Please refer to FIG. 4, this embodiment is based on the first embodiment, the method that the PC end application program installs the application program which is previously downloaded to the PC and is related to the PC end application program to the mobile apparatus, further includes:

step S320: detecting the mobile apparatus installed with the application program and a version of the application program which is order than the version of the application program previously downloaded to the PC, by the PC end application program;

step S340: updating and installing the application program previously downloaded to the PC to the mobile apparatus, by the PC end application program.

In the step S320, the PC end application program reads an installation state of the mobile apparatus, when detecting that the mobile apparatus is installed with the application program and the version of the application program is older than the version of the application program previously downloaded to the PC, for example, the PC end application program is detected that the mobile apparatus is installed with five application programs A, B, C, D, E and F, the application program previously downloaded to the PC is F, and it is detected that the version of the application program F on the mobile apparatus is V1.0, and the version of the application program F previously downloaded to the PC is V2.0, which means that the application program is already installed into the mobile apparatus, and the version is older than the version of the application program previously downloaded to the PC. This embodiment is based on that the mobile apparatus is already installed with the application program and the version of the application program is older than the version of the application program previously downloaded to the PC, if the mobile apparatus is already installed with the application program, and the version of the application program is the same as the version of the application program previously downloaded to the PC, it is not adapted to the method of the present disclosure, it is needed to be pointed out that the version of the application program which is already installed on the mobile apparatus is impossible newer than the version of the application program previously downloaded to the PC, because the PC end application program will perform real-time update to update the version of the application program previously downloaded to the PC, which ensures that the version of the application program previously downloaded to the PC is the latest version.

In the step S340, the updating installation means that the application program is already installed into the mobile apparatus and its version is older, the PC end application program will install the latest version of the application program previously downloaded to the PC and replace the older version of the application program previously installed on the mobile apparatus. Everybody knows that the application program in the newer version can provide better user experience than the application program in older version, that is, for ensuring that the use can has the best user experience during using the application program on the mobile apparatus.

### Fourth Embodiment

Please refer to FIG. 5, this embodiment can be based on any one of the first to third embodiments, after the method that the PC end application program installs the application program which is previously downloaded to the PC and is related to the PC end application program to the mobile apparatus, further includes:

step S400: the PC end application program reads the data of the PC end application program in operation;

step S500: the PC end application program synchronously transfers the data to the application program of the mobile apparatus.

In the step S400, after the PC end application program installs the application program to the mobile apparatus, the PC end application program will read the data of the PC end application program in operation, wherein, according to the differences in the PC end application program, the data can include: name of the show viewed by the user and it's state or name of the downloaded file, and it's download address, download state .etc, the present disclosure is not limited to the form of the data, the operating data general means any data related to the operation of the PC end application program.

In the step S500, continued from the step S400, the PC end application program synchronously transfers the read data to the mobile apparatus, specifically, to the application program installed in the mobile apparatus, for example, name of the show viewed by the user and it's state will be transferred to the application program of the mobile apparatus, for ensuring that the user can obtain the usage state of the PC end application program when the PC is closed, and thereby connecting the PC end application program and the application program of the mobile apparatus. It is needed to be pointed out that: the step that the PC end application program reads and synchronously transfers the operating data of the PC end application program is performed after the mobile apparatus being installed with the application program, which can ensure that the data obtained by the operating data of the PC end application program and the application program of the mobile apparatus has no delay so that the user experience can be improved; In addition, when the PC end application program reads and synchronously transfers the operating data of the PC end application program to the application program of the mobile apparatus, the application program of the mobile apparatus has no needed to be entirely opened, it is only needed to open the information receiving process of the mobile apparatus in background.

### Fifth Embodiment

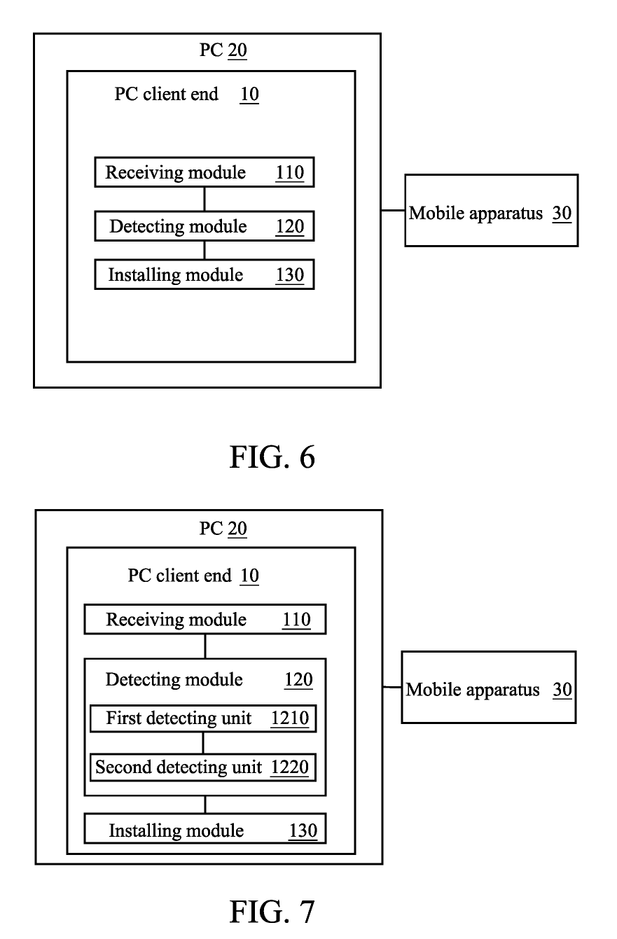

Please refer to FIG. 6, for solving the problem in the traditional technology that the method for transferring the application program from the PC end to the mobile apparatus end will affect user experience and is low in transferring efficiency. The fifth embodiment of the present disclosure provides a electronic apparatus 10 for transferring the application program from the PC to the mobile apparatus, wherein, the PC 20 is a personal computer, the mobile apparatus 30 includes smartphone, tablet computer .etc, the electronic apparatus 10 (application program) is a software operated in the PC 20, the application program (application program) is a software installed in the mobile apparatus 30, but these aforementioned examples are classic names in the art of the present disclosure, the present disclosure is not limited thereto. The electronic apparatus 10 is installed on the PC 20 and is in the opened state, the electronic apparatus 10 includes a receiving module 110, a detecting module 120 and an installing module 130.

The receiving module 110 is used to receive information that the mobile apparatus is already connected to the PC sent from the PC through a PC end application program which is installed at the PC and in an opened state.

The detecting module 120 is used to detect whether the mobile apparatus is permitted to install the application program to the mobile apparatus and whether a user agrees to install the application program to the mobile apparatus.

The installing module 130 is used to install the application program, which is previously downloaded to the PC and related to the PC end application program, to the mobile apparatus through the PC end application program when the mobile apparatus is permitted to install the application program to the mobile apparatus and the user agrees to install the application program to the mobile apparatus.

In another embodiment of the present disclosure, the electronic apparatus 10 and the application program are respectively a PC version and a mobile apparatus version of the same application program, for example, the PC end application program is a PC version of LETV, and the application program is a mobile version of LETV, but the present disclosure is not limited to this example. It is conceivable that the PC end application program can transfer different application programs to the mobile apparatus.

### Sixth Embodiment

Please refer to FIG. 7, which is another block diagram illustrating a electronic apparatus for transferring the application program from the PC to the mobile apparatus according to a sixth embodiment of the present disclosure, this embodiment is based on the fifth embodiment, the detecting module 120 further includes a first detecting unit 1210 and a second detecting unit 1220.

The first detecting unit 1210 is used to detect whether the mobile apparatus is at a transferable state through the PC end application program, wherein, the transferable state includes: when the mobile apparatus 30 is connected to the PC 20 via a USB data cable, a USB debugging mode of the mobile apparatus 30 is opened, and the mobile apparatus 30 is already agreed with authorization; or when the mobile apparatus 30 is connected to the PC 20 via wireless way, the mobile apparatus 30 is already agreed with authorization.

The second detecting unit 1220 is used to detect whether receiving the instruction that the user agrees to install the application program to the mobile apparatus 30.

### Seventh Embodiment

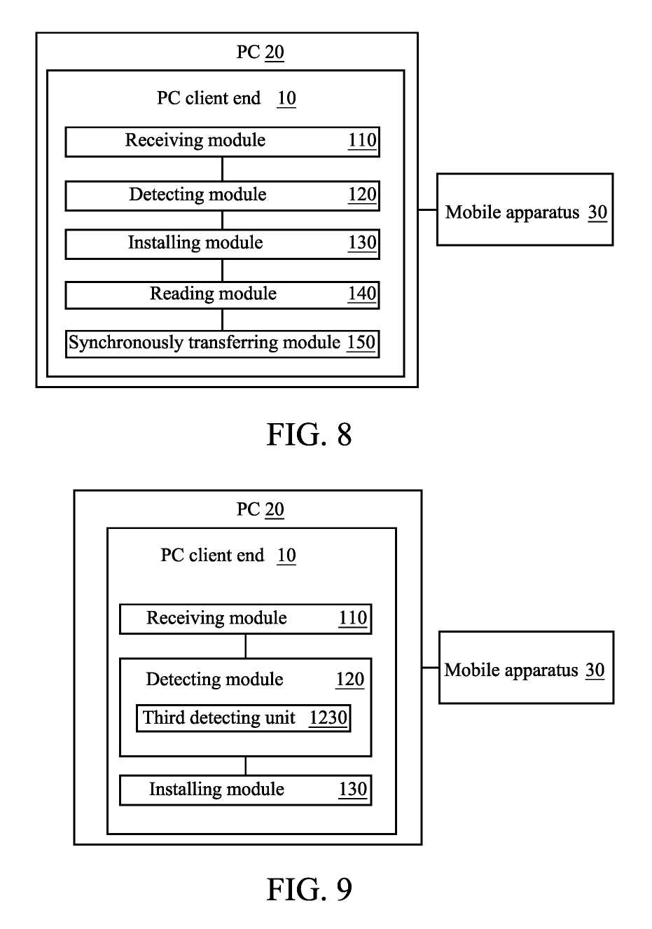

Please refer to FIG. 8, which is yet another block diagram illustrating a electronic apparatus for transferring the application program from the PC to the mobile apparatus according to a seventh embodiment of the present disclosure, this embodiment is based on the fifth embodiment, the electronic apparatus 10 further includes a reading module 140 and a synchronously transferring module 150.

The reading module 140 is used to read the data currently operated by the electronic apparatus 10.

The synchronously transferring module 150 is used to synchronously transfer the data to the application program of the mobile apparatus 30.

### Eighth Embodiment

Please refer to FIG. 9, which is yet another block diagram illustrating a electronic apparatus for transferring the application program from the PC to the mobile apparatus according to a eighth embodiment of the present disclosure, this embodiment is based on the fifth embodiment, the detecting module 120 further includes a third detecting unit 1230.

The third detecting unit 1230 is used to detect whether the mobile apparatus 30 is installed with the application program, when it is detected that the mobile apparatus 30 is not installed with the application program, the installing module 130 is informed to install the application program previously downloaded to the PC 20 and related to the PC end application program to the mobile apparatus 30 for the first time.

### Ninth Embodiment

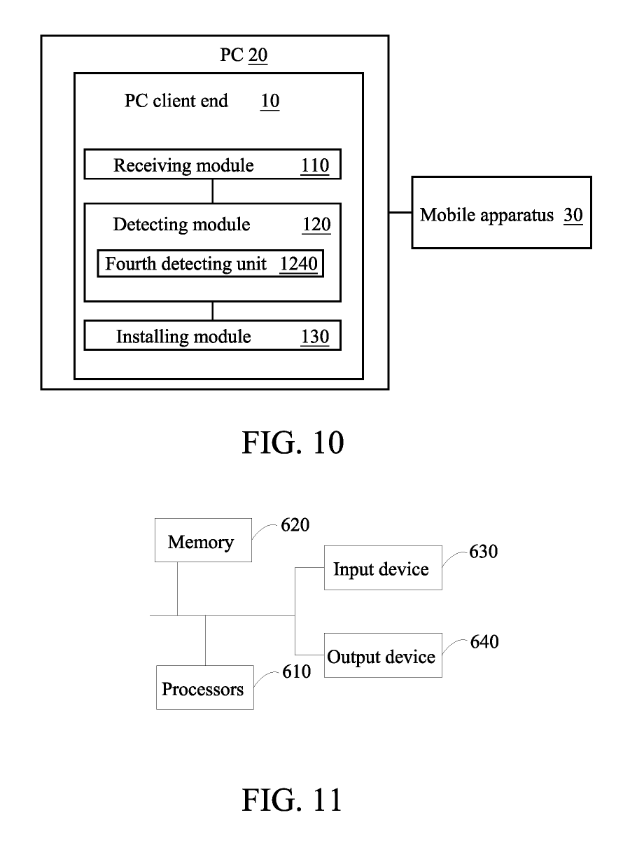

Please refer to FIG. 10, which is yet another block diagram illustrating a electronic apparatus for transferring the application program from the PC to the mobile apparatus according to a ninth embodiment of the present disclosure, this embodiment is based on the fifth embodiment, the detecting module 120 further includes a fourth detecting unit 1240.

The fourth detecting unit 1240 is used to detect the mobile apparatus 30 installed with the application program and a version of the application program which is order than the version of the application program previously downloaded to the PC 20, and inform the installing module 130 to update and install the application program which is previously downloaded to the PC 20 and related to the PC end application program to the mobile apparatus 30.

If there is anything unclear about the embodiments of the electronic apparatus for transferring the application program from the PC to the mobile apparatus, please refer to the method of the aforementioned embodiments for transferring the application program from the PC to the mobile apparatus.

### Tenth Embodiment

One embodiment of the present disclosure provides a non-volatile computer storage medium capable of storing computer-executable instruction. The said computer-executable instruction is used for performing any one of the steps in above.

### Eleventh Embodiment

FIG. 11 is a schematic view of an electronic apparatus provided by the eleventh embodiment illustrating that the method for transferring the application program from the PC to the mobile apparatus a PC client end according to one embodiment of the present disclosure. As shown in FIG. 11, the apparatus includes:

a memory 620 and one or more processors 610. FIG. 11 is an example showing that the electronic apparatus having one processor 610.

The apparatus includes: an input device 630 and an output device 640.

The processor 610, the memory 620, the input device 630 and the output device 640 can be connected to each other via a bus or other members for electrical connection. In FIG. 11, they are connected to each other via the bus in this embodiment.

The memory 620 is one kind of non-volatile computer-readable storage mediums applicable to store non-volatile software programs, non-volatile computer-executable programs and modules; for example, the program instructions and the function modules (the receiving module 110, the detecting module 120 and installing module 130 in FIG. 6) corresponding to the method in the embodiments are respectively a computer-executable program and a computer-executable module. The processor 610 executes function applications and data processing of the server by running the non-volatile software programs, non-volatile computer-executable programs and modules stored in the memory 620, and thereby the methods in the aforementioned embodiments are achievable.

The memory 620 can include a program storage area and a data storage area, wherein the program storage area can store an operating system and at least one application program required for a function; the data storage area can store the data created according to the usage of the device for intelligent recommendation. Furthermore, the memory 620 can include a high speed random-access memory, and further include a non-volatile memory such as at least one disk storage member, at least one flash memory member and other non-volatile solid state storage member. In some embodiments, the memory 620 can have a remote connection with the processor 610, and such memory can be connected to the device of the present disclosure by a network. The aforementioned network includes, but not limited to, internet, intranet, local area network, mobile communication network and combination thereof.

The input device 630 can receive digital or character information, and generate a key signal input corresponding to the user setting and the function control of the device for intelligent recommendation. The output device 640 can include a displaying unit such as screen.

The one or more modules are stored in the memory 620. When the one or more modules are executed by one or more processor 610, the methods disclosed in any one of the embodiments is performed.

The aforementioned product can perform the method of the present disclosure, and has function module for performing it. The details not thoroughly illustrated in this embodiment can be referenced via the methods in the present disclosure.

The electronic apparatus in the embodiments of the present application is presence in many forms, and the electronic apparatus includes, but not limited to:

(1) Mobile communication apparatus: characteristics of this type of device are having the mobile communication function, and providing the voice and the data communications as the main target. This type of terminals include: smart phones (e.g. iPhone), multimedia phones, feature phones, and low-end mobile phones, etc.

(2) Ultra-mobile personal computer apparatus: this type of apparatus belongs to the category of personal computers, there are computing and processing capabilities, generally includes mobile Internet characteristic. This type of terminals include: PDA, MID and UMPC equipment, etc., such as iPad.

(3) Portable entertainment apparatus: this type of apparatus can display and play multimedia contents. This type of apparatus includes: audio, video player (e.g. iPod), handheld game console, e-books, as well as smart toys and portable vehicle-mounted navigation apparatus.

(4) Server: an apparatus provide computing service, the composition of the server includes processor, hard drive, memory, system bus, etc, the structure of the server is similar to the conventional computer, but providing a highly reliable service is required, therefore, the requirements on the processing power, stability, reliability, security, scalability, manageability, etc. are higher.

(5) Other electronic apparatus having a data exchange function.

The aforementioned embodiments are exemplary, the description of separated units can be physically connected, and the unit capable of displaying image can not be a physical unit, that is, it can be located on a place or distributed to plural internet units. It is selectively to select a part or all of the modules for achieving the purpose of the present disclosure.

By the aforementioned embodiments, the people skilled in the art can thoroughly understand that the embodiments can be implemented by software and hardware platform. Accordingly, the technique, features or the part having contribution can be embodied through software product, the software product can be stored in computer readable medium, such as ROM/RAM, hard disk, optical disc, including one or more instructions so that a computing apparatus (e.g. personal computer, server, or internet apparatus) can execute each embodiment or some methods discussed the embodiments.

It is further noted that: the embodiments in above are only used to explain the features of the present application, but not used to limit the present application; although the present application is explained by the embodiments, the people skilled in the art would know that the features in the aforementioned embodiments can be modified, or a part of the features can be replaced, and the features relating to these modification or replacement are still in the scope and spirit of the present application.

What is claimed is:

1. A method for transferring application program from a PC to a mobile apparatus, comprising:
receiving information that the mobile apparatus is already connected to the PC sent from the PC by a PC end application program which is installed at the PC and in an opened state;
detecting whether the mobile apparatus is permitted to install the application program to the mobile apparatus and whether a user agrees to install the application program to the mobile apparatus, by the PC end application program; and
installing the application program, which is previously downloaded to the PC and related to the PC end application program, to the mobile apparatus by the PC end application program when the mobile apparatus is permitted to install the application program to the mobile apparatus and the user agrees to install the application program to the mobile apparatus.

2. The method according to claim 1, wherein the step that the PC end application program detects whether the mobile apparatus is permitted to install the application program and whether the user agrees to install the application program to the mobile apparatus, further comprising:
detecting whether the mobile apparatus is at a transferable state by the PC end application program, wherein, the transferable state comprises: when the mobile apparatus is connected to the PC via a USB data cable, a USB debugging mode of the mobile apparatus is opened, and the mobile apparatus is already agreed with authorization; or when the mobile apparatus is connected to the PC via wireless way, the mobile apparatus is already agreed with authorization; and
detecting whether receiving the instruction that the user agrees to install the application program to the mobile apparatus.

3. The method according to claim 1, wherein the step that the PC end application program install the application program which are previously downloaded to the PC and related to the PC end application program to the mobile apparatus, further comprising:
detecting the mobile apparatus not installed the application program yet, by the PC end application program; and
installing the application program previously downloaded to the PC to the mobile apparatus for the first time, by the PC end application program.

4. The method according to claim 1, wherein the step that the PC end application program install the application program which are previously downloaded to the PC and related to the PC end application program to the mobile apparatus, further comprising:
detecting the mobile apparatus installed with the application program and a version of the application program which is order than the version of the application program previously downloaded to the PC, by the PC end application program; and
updating and installing the application program previously downloaded to the PC to the mobile apparatus, by the PC end application program.

5. The method according to claim 1, wherein the PC end application program and the application program are respectively a PC version and a mobile apparatus version of the same application program.

6. A non-volatile computer storage medium capable of storing computer-executable instruction, the computer-executable instruction comprising:
receiving information that the mobile apparatus is already connected to the PC sent from the PC by a PC end application program which is installed at the PC and in an opened state;
detecting whether the mobile apparatus is permitted to install the application program to the mobile apparatus and whether a user agrees to install the application program to the mobile apparatus, by the PC end application program; and
installing the application program, which is previously downloaded to the PC and related to the PC end application program, to the mobile apparatus by the PC end application program when the mobile apparatus is permitted to install the application program to the mobile apparatus and the user agrees to install the application program to the mobile apparatus.

7. An electronic apparatus, comprising:
at least one processor; and
a memory communicatively connected to the at least one processor; wherein
the memory stores computer-executable instruction which is executable by the at least one processor, when the computer-executable instruction is executed by the at least processor, the at least one processor is able to:
receiving information that the mobile apparatus is already connected to the PC sent from the PC by a PC end application program which is installed at the PC and in an opened state;
detecting whether the mobile apparatus is permitted to install the application program to the mobile apparatus and whether a user agrees to install the application program to the mobile apparatus, by the PC end application program; and
installing the application program, which is previously downloaded to the PC and related to the PC end application program, to the mobile apparatus by the PC end application program when the mobile apparatus is permitted to install the application program to the mobile apparatus and the user agrees to install the application program to the mobile apparatus.

8. The non-volatile computer storage medium according to claim 6, wherein the step that the PC end application program detects whether the mobile apparatus is permitted to install the application program and whether the user agrees to install the application program to the mobile apparatus, further comprising:
detecting whether the mobile apparatus is at a transferable state by the PC end application program, wherein, the transferable state comprises: when the mobile apparatus is connected to the PC via a USB data cable, a USB debugging mode of the mobile apparatus is opened, and the mobile apparatus is already agreed with authorization; or when the mobile apparatus is connected to the PC via wireless way, the mobile apparatus is already agreed with authorization; and
detecting whether receiving the instruction that the user agrees to install the application program to the mobile apparatus.

9. The non-volatile computer storage medium according to claim 6, wherein the step that the PC end application program install the application program which are previously downloaded to the PC and related to the PC end application program to the mobile apparatus, further comprising:
detecting the mobile apparatus not installed the application program yet, by the PC end application program; and
installing the application program previously downloaded to the PC to the mobile apparatus for the first time, by the PC end application program.

10. The non-volatile computer storage medium according to claim 6, wherein the step that the PC end application program install the application program which are previously downloaded to the PC and related to the PC end application program to the mobile apparatus, further comprising:
detecting the mobile apparatus installed with the application program and a version of the application program which is order than the version of the application program previously downloaded to the PC, by the PC end application program; and
updating and installing the application program previously downloaded to the PC to the mobile apparatus, by the PC end application program.

11. The non-volatile computer storage medium according to claim 6, wherein the PC end application program and the application program are respectively a PC version and a mobile apparatus version of the same application program.

12. The electronic apparatus according to claim 7, wherein the step that the PC end application program detects whether the mobile apparatus is permitted to install the application program and whether the user agrees to install the application program to the mobile apparatus, further comprising:
detecting whether the mobile apparatus is at a transferable state by the PC end application program, wherein, the transferable state comprises: when the mobile apparatus is connected to the PC via a USB data cable, a USB debugging mode of the mobile apparatus is opened, and the mobile apparatus is already agreed with authorization; or when the mobile apparatus is connected to the PC via wireless way, the mobile apparatus is already agreed with authorization; and
detecting whether receiving the instruction that the user agrees to install the application program to the mobile apparatus.

13. The electronic apparatus according to claim 7, wherein the step that the PC end application program install the application program which are previously downloaded to the PC and related to the PC end application program to the mobile apparatus, further comprising:
detecting the mobile apparatus not installed the application program yet, by the PC end application program; and
installing the application program previously downloaded to the PC to the mobile apparatus for the first time, by the PC end application program.

14. The electronic apparatus according to claim 7, wherein the step that the PC end application program install the application program which are previously downloaded to the PC and related to the PC end application program to the mobile apparatus, further comprising:
detecting the mobile apparatus installed with the application program and a version of the application program which is order than the version of the application program previously downloaded to the PC, by the PC end application program; and
updating and installing the application program previously downloaded to the PC to the mobile apparatus, by the PC end application program.

15. The electronic apparatus according to claim 7, wherein the PC end application program and the application program are respectively a PC version and a mobile apparatus version of the same application program.
